(19) United States
(12) Patent Application Publication
(10) Pub. No.: US 2010/0091425 A1
(43) Pub. Date: Apr. 15, 2010

(54) ELECTRONIC COMPONENT AND METHOD FOR PRODUCING THE SAME

(75) Inventors: Hiroki Takeoka, Osaka (JP); Hiroshi Fujii, Toyama (JP); Yukihiro Shimasaki, Hyogo (JP); Kenji Nakatani, Tokyo (JP)

Correspondence Address: STEPTOE & JOHNSON LLP, 1330 CONNECTICUT AVE., NW, WASHINGTON, DC, 20036, US

(73) Assignees: Panasonic Corporation, Kadoma-shi, Osaka (JP); Rimtec Corporation, Tokyo (JP)

(21) Appl. No.: 12/519,564

(22) PCT Filed: Nov. 27, 2007
(86) PCT No.: PCT/JP2007/072796

§ 371 Date: Jun. 25, 2009

(30) Foreign Application Priority Data
Dec. 22, 2006 (JP) 2006-345101

(51) Int. Cl. H01G 4/30; H01G 4/32; B29C 45/14

(52) U.S. Cl. 361/301.4; 361/301.5; 264/272.15

(57) ABSTRACT

The present invention provides an electronic component which can reduce the size of a capacitor and the number of constitutional parts of the capacitor without using a case. The electronic component of the present invention includes a capacitor element, an outer package made of a norbornene resin covering the capacitor element, and external connection terminal portions electrically connected to the capacitor element and protruded from the outer package.

### TECHNICAL FIELD

The present invention relates to an electronic component including a component element such as a capacitor element.

### BACKGROUND ART

FIG. 5 is a sectional view showing a capacitor of the prior art. In FIG. 5, reference numeral 21 denotes a capacitor element, reference numeral 22 denotes a pair of positive and negative conductive members, reference numeral 23 denotes a pair of external connection terminal portions, reference numeral 24 denotes a resin case, and reference numeral 25 denotes filling resin.

The capacitor element 21 is made up of two wound metallized films, each being prepared by evaporating a metal on one surface of a dielectric film. The conductive members 22 are made of copper and are connected to the end faces of the capacitor element 21. As shown in FIG. 5, the conductive members 22 are formed to protrude outward and have portions exposed to the outside of the conductive members 22 and composing the external connection terminal portions 23.

The resin case 24 has an opening on top of the case. In the resin case 24, the capacitor element 21 connected to the conductive members 22 is placed. The filling resin 25 for molding the capacitor element 21 is added so as to expose only the external connection terminal portions 23 to the outside from a clearance between the inner surface of the case 24 and the outer surface of the capacitor element 21. Generally, the filling resin 25 is an epoxy resin.

The filling resin 25 covers the capacitor element 21 to prevent the capacitor element 21 from being exposed to moisture. The filling resin 25 improves the moisture resistance of a product. Further, the filling resin 25 acts as a robust case taking advantage of resin characteristics including high strength and impact resistance.

As has been discussed, in the prior art, the capacitor element is placed in the resin case and the epoxy resin is filled and cured in a clearance between the inner surface of the case and the outer surface of the capacitor element, so that the moisture resistance of the product is improved (for example, see Patent Documents 1 and 2).

Patent Document 1: Japanese Patent Laid-Open No. 2000-58380

Patent Document 2: Japanese Patent Laid-Open No. 2000-323352

### DISCLOSURE OF THE INVENTION

### Problems to be Solved by the Invention

As has been discussed, in a capacitor of the prior art, an epoxy resin is filled and cured in a clearance between a capacitor element and a resin case. Resin cases are used in the prior art because when a mold is used, the mold and the epoxy resin may be bonded to each other and working efficiency may decrease. However, cases used as in the prior art increase the sizes of products and the number of components.

The present invention has been devised in view of the foregoing problem. An object of the present invention is to provide an electronic component and a method for producing the same which can reduce the size of a capacitor and the number of constitutional parts of the capacitor without using a case.

### Means for Solving the Problem

In order to attain the object, a feature of an electronic component of the present invention is that a component element is covered with an outer package formed by molding a norbornene resin. A feature of a method for producing the electronic component according to the present invention is that the outer package is obtained by reaction injection molding in which a norbornene monomer is injected, is caused to react, and is cured.

The electronic component according to the present invention includes a capacitor element, the outer package made of a norbornene resin covering the capacitor element, and external connection terminal portions electrically connected to the capacitor element and protruded from the outer package.

The electronic component according to the present invention, wherein the outer package is made of the norbornene resin in which a filler of 5 wt % to 50 wt % is added.

The electronic component according to the present invention further includes a pair of positive and negative electrodes provided on the capacitor element, and conductive members which are connected to the respective electrodes and a part of which compose the external connection terminal portions.

The electronic component according to the present invention, wherein the capacitor element is made up of metallized films which are wound or stacked.

The electronic component according to the present invention, wherein the capacitor element has a track-shaped cross section.

The electronic component according to the present invention further includes uneven portions formed on the surface of the outer package.

A method for producing an electronic component according to the present invention is a method for producing the foregoing electronic component, after the capacitor element is mounted in a mold for resin molding, the method including: injecting a norbornene monomer from a resin inlet formed on the mold, and molding the outer package for covering the capacitor element, according to reaction injection molding in which the injected norbornene monomer is caused to react and cured.

### Advantage of the Invention

According to a preferred embodiment of the present invention, it is possible to reduce the size of a capacitor and the number of constitutional parts of the capacitor without using a case, thereby reducing manufacturing cost. Further, according to the preferred embodiment of the present invention, a norbornene resin can be cured in a short time, so that the productivity of the capacitor can be remarkably improved.

### BRIEF DESCRIPTION OF THE DRAWINGS

FIG. 1 is a schematic sectional view showing a capacitor serving as an electronic component in an embodiment of the present invention;

FIG. 2 is a schematic diagram showing a mold for molding the outer package of the capacitor serving as the electronic component in the embodiment of the present invention;

FIG. 3 is a perspective view showing the outside shape of the capacitor serving as the electronic component in the embodiment of the present invention;

FIG. 4 is a perspective view showing another example of the outside shape of the capacitor serving as the electronic component in the embodiment of the present invention; and

FIG. 5 is a sectional view showing a capacitor of the prior art.

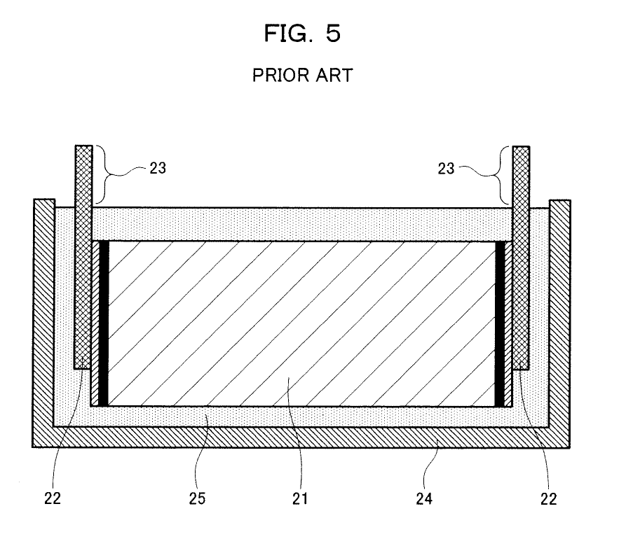

### BEST MODE FOR CARRYING OUT THE INVENTION

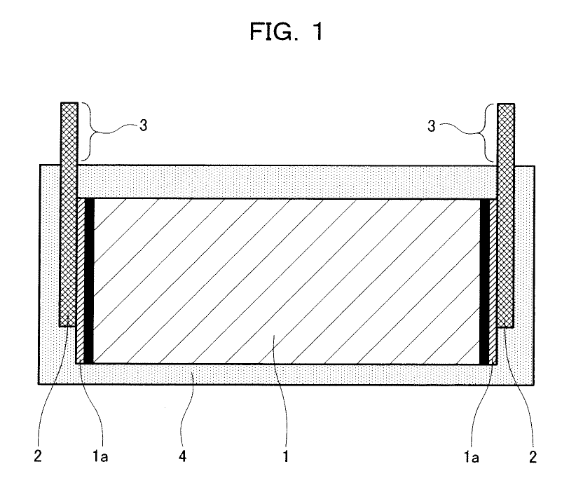

The following will describe an embodiment of an electronic component and a method for producing the same of the present invention in accordance with the accompanying drawings. FIG. 1 is a sectional view of a capacitor which is an electronic component of the present embodiment. In the present embodiment, a metallized film capacitor will be illustrated as a capacitor. The electronic component of the present invention is not limited to a metallized film capacitor.

In FIG. 1, reference numeral 1 denotes a capacitor element, reference character 1a denotes a pair of positive and negative electrodes, reference numeral 2 denotes a pair of conductive members, reference numeral 3 denotes a pair of external connection terminal portions, and reference numeral 4 denotes an outer package. In the capacitor element 1, a pair of metallized films (not shown) are wound or stacked so as to be opposed to each other via a dielectric film (not shown), the metallized film being prepared by evaporating a metal such as aluminum on a dielectric film made of polypropylene and so on. Further, the electrodes 1a are formed on both end faces of the capacitor element 1 by metal spraying. The electrodes are formed by, for example, spraying zinc and the like.

The conductive members 2 each have one end connected to the metal sprayed electrode la via solder and so on. The other ends of the conductive members 2 compose the external connection terminal portions 3. The conductive members 2 are formed so as to protrude the external connection terminal portions 3 to the outside. The conductive members 2 are made up of, for example, plate-like bus bars or linear conductors.

The outer package 4 covers the capacitor element 1 with the external connection terminal portions 3 exposed from the outer package 4. In this configuration, the outer package 4 is a molded article of a norbornene resin and is molded by reaction injection molding (RIM). Norbornene resin articles molded by RIM are generally used for, for example, vehicles, construction machines, agricultural machinery covers, bathtub pans, septic tank enclosures, and household appliances such as washbowls. As disclosed in Japanese Patent Laid-Open No. 10-296792, a norbornene resin is also used as a filling resin of a ground propulsion coil for a magnetic levitation train.

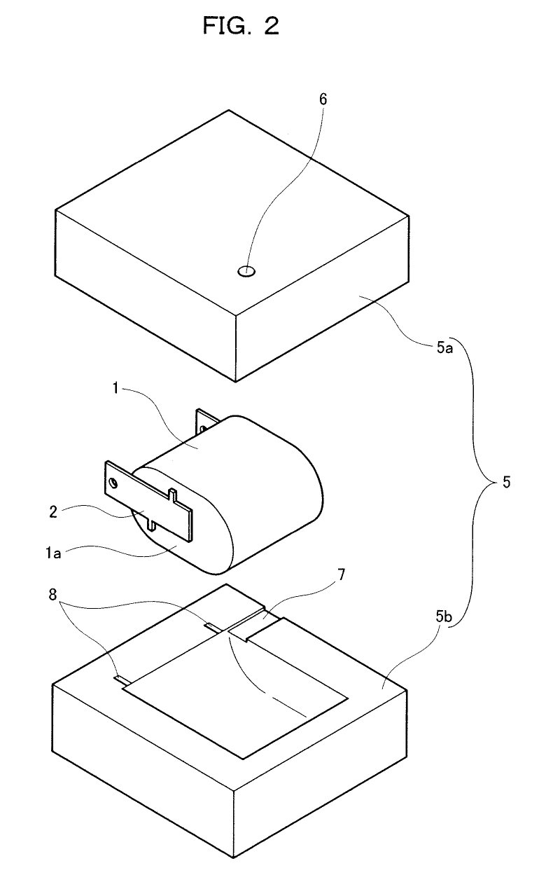

The outer package 4 is molded using a mold. FIG. 2 shows the mold for molding the outer package 4. In FIG. 2, reference numeral 5 denotes the mold, reference character 5a denotes the cope of the mold 5, reference character 5b denotes the drag of the mold 5, reference numeral 6 denotes a gate, reference numeral 7 denotes an air vent port, and reference numeral 8 denotes recessed portions.

As shown in FIG. 2, the mold 5 for resin molding is made up of the cope 5a and the drag 5b. On the cope 5a, the gate 6 is formed as a hole for introducing resin (resin inlet). Further, on the mating surfaces of the cope 5a and the drag 5b, the air vent port 7 is formed for evacuating air from the inside of the mold 5 during cast molding of resin. Moreover, on the mating surfaces of the cope 5a and the drag 5b, the recessed portions 8 for fixing and positioning the capacitor element 1 are formed.

In a method for molding the outer package 4, first, the capacitor element 1 connected to the conductive members 2 is mounted in the mold 5. At this point, the conductive members 2 are fixed by the recessed portions 8 of the cope 5a and the drag 5b, the capacitor element 1 is positioned, and the mold 5 is clamped by fitting the cope 5a and the drag 5b. The mold may be a simple molding box. The mold is preferably adjusted to at least room temperature, more preferably to 50° C. to 120° C., to accelerate reaction when a norbornene monomer is injected.

After clamping, in order to evacuate air from the air vent port 7, the mold 5 is tilted so as to lower the gate 6; meanwhile, the norbornene monomer is injected into the mold 5 through the gate 6 and is cured therein. Air in the mold 5 is discharged from the air vent port 7 to the outside. An injection pressure at this point is substantially equal to an atmospheric pressure. After that, the mold 5 is opened and the metallized film capacitor is obtained.

As has been discussed, the outer package 4 is obtained by performing reaction injection molding and bulk polymerization on the norbornene monomer. The norbornene monomer may be any compound as long as the compound has a norbornene ring system. Particularly, polycyclic norbornene monomers including at least a tricyclic norbornene monomer are preferable because a molded article can be obtained with high heat resistance. For example, a polycyclic norbornene monomer may be obtained by polymerization of a mixed solution which properly contains dicyclopentadiene as a main component and contains a polycyclic norbornene monomer such as tricyclopentadiene and tetracyclopentadiene and a comonomer of monocyclic cycloolefin which can be subjected to ring-opening copolymerization with a norbornene monomer and includes cyclobutene and cyclopentene, within the object of the present invention. A specific example is dicyclopentadiene (DCPD) of two-liquid type which has been marketed under the trade names of “PENTAM” and “METTON” from RIMTEC Corporation. As a matter of course, the norbornene monomer used for the outer package 4 is not limited to “PENTAM” and “METTON”.

For polymerizing a norbornene monomer, a metathesis catalyst is suitable. For example, a metathesis catalyst of metal salt such as tungsten, molybdenum, and ruthenium can be used. Any well-known activator may be used as long as the metathesis catalyst can be activated. For example, as disclosed in Japanese Patent Laid-Open No. 6-145247, the activator may be one or a combination of at least two of an organic aluminum compound such as aluminum alkyl and aluminum alkyl halide and an organic tin compound and the like. Generally, in RIM, a two-liquid system is used in which liquid B prepared by adding a metathesis catalyst to a norbornene monomer and liquid A prepared by adding an activator to a norbornene monomer are used. The liquids A and B injected into the mold start a reaction and are cured concurrently with mixing.

In order to completely cover the capacitor element with resin, it is necessary to select the optimum curing rate and viscosity of the norbornene monomer (liquids A and B). The curing rate can be adjusted by adding an activity regulator. The activity regulator may be a compound and the like which can reduce a metathesis catalyst. For example, alcohols, haloalcohols, or acetylenes are preferable. Further, for some kinds of metathesis catalyst, a Lewis base compound can be used as an activity regulator.

The viscosity can be adjusted by adding elastomers. The elastomers include, for example, natural rubber, a styrene-butadiene copolymer (SBR), a styrene-butadiene-styrene block copolymer (SBS), a styrene-isoprene-styrene copolymer (SIS), and an ethylene-propylene-diene terpolymer (EPDM). The viscosity can be adjusted from about 5 cps (5×10⁻³ Pas) to 2000 cps (2 Pas) at 30° C. according to an amount of estolamers added.

As has been discussed, in the present embodiment, the capacitor element is covered with the norbornene resin. The norbornene monomer is normally cured in about 5 minutes to 10 minutes after the monomer is injected, depending on the amount of activity regulator added. On the other hand, in a capacitor of the prior art, at least one to several hours are necessary for curing an epoxy resin used as a filling resin. The norbornene monomer can be cured in quite a short time. Therefore, the productivity of a product can be improved by using the norbornene resin.

Moreover, the norbornene resin has higher moisture resistance and rigidity as compared with thermosetting resins including an epoxy resin used as a filling resin in capacitors of the prior art and polyester resins and the like used for cases in the prior art. Thus only by covering the capacitor element with the outer package made of the norbornene resin, the moisture resistance, strength, and impact resistance can be obtained. It is therefore possible to eliminate the need for cases unlike capacitors of the prior art and obtain a smaller capacitor. Moreover, since the norbornene resin has high strength and impact resistance, the outer package can be reduced in thickness. Thus it is possible to reduce the material cost as well as the size of the capacitor. As the outer package increases in rigidity and decreases in thickness, reliability against vibrations of the capacitors increases.

An epoxy resin and the like used as a filling resin in a capacitor of the prior art have a high viscosity and thus working efficiency decreases in cast molding for injecting resin, whereas the norbornene monomer has a low viscosity and increases working efficiency, so that operating cost can be reduced. An antioxidant or a flame retardant may be added to the norbornene monomer as necessary. Further, a small amount of carbon may be added to turn the norbornene monomer black.

Further, by adding a filler to the norbornene monomer, the rigidity of the outer package 4 can be increased and a coefficient of linear expansion can be reduced. It is generally known that the performance of a polymer is improved by inorganic fillers and fibers. However, some inorganic fillers and fibers may considerably reduce strength. In an extreme case, the reactivity of the norbornene monomer may be interfered and result in poor polymerization and curing. Thus it is necessary to carefully select inorganic fillers and fibers to be added to the norbornene monomer.

In this case, the filler may be calcium carbonate, calcium silicate, calcium sulfate, aluminum hydroxide, magnesium hydroxide, titanium oxide, zinc oxide, barium titanate, talc, mica, silica, alumina, carbon black, graphite, antimony oxide, red phosphorus, metal powders, clay, ferrites, hydrotalcite, glass fiber, wollastonite, potassium titanate, xonolite, basic magnesium sulfate, aluminum borate, tetrapod zinc oxide, gypsum fibers, phosphate fibers, alumina fibers, acicular calcium carbonate, acicular boehmite, scaly boehmite, tabular boehmite, and so on. In consideration of the cost, calcium carbonate, calcium silicate, silica, wollastonite, and the like are preferably used. One of the fillers may be used or some of the fillers may be mixed. By adding the filler to the norbornene monomer, the rigidity of a molded article can be increased and dimensional stability can be obtained by reducing a coefficient of linear expansion.

The fillers are spherical, acicular, and fibrous in shape. In RIM, a hybrid filler obtained from fillers having different shapes is preferably used to obtain the dispersibility of fillers in a reaction liquid. A hybrid filler can be obtained by stirring at least two fillers at high speeds according to dry process. Stirring conditions during high-speed stirring are not particularly limited. For example, the fillers are stirred using a Henschel mixer and the like such that a rotor blade normally has a circumferential speed of 10 m/second to 60 m/second.

Further, the fillers preferably have a 50%-volume cumulative diameter of 1 μm to 30 μm. The 50%-volume cumulative diameter is a value determined by measuring a particle size distribution by X-ray radiography. A too small 50%-volume cumulative diameter may cause insufficient rigidity and dimensional stability of a molded article. A too large 50%-volume cumulative diameter may settle a reaction liquid in a tank, a mold, and a pipe and may clog an injection nozzle with the reaction liquid.

Generally, the content of the hybrid filler is 5 wt % to 50 wt %, preferably 10 wt % to 40 wt % relative to the norbornene monomer depending on the kind of filler. When the content is small, the filler cannot fully exhibit the effect of increasing the rigidity and reducing the coefficient of linear expansion. When the content exceeds 50 wt %, the molded article may become brittle or may be insufficiently cured, so that the outer package cannot be configured by RIM. When a large amount of filler is added, the flow resistance of a liquid increases and may disadvantageously increase the viscosity of the norbornene monomer. Even when the amount of hybrid filler added is relatively large, the viscosity can be suppressed because the hybrid filler has high dispersibility in a reaction liquid. Moreover, the viscosity can be suppressed by treating a filler surface with a finishing agent.

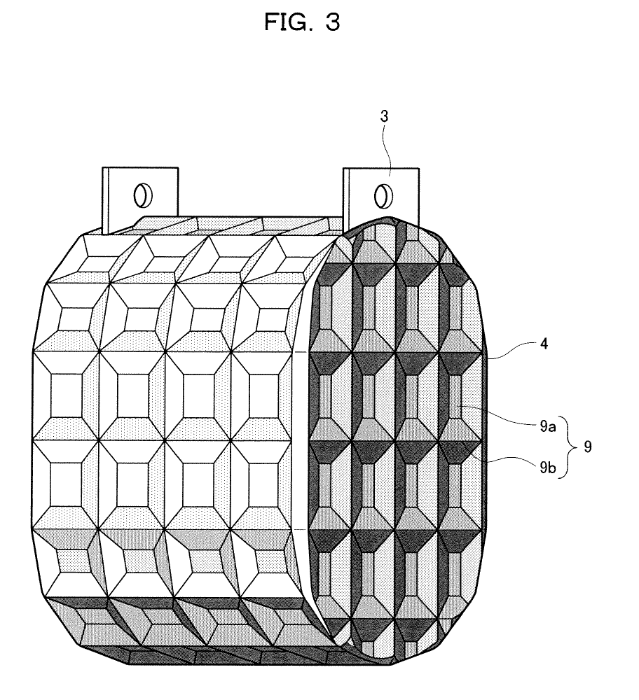

The following will describe the outside shape of a capacitor in the present embodiment. FIG. 3 is a perspective view showing the outside shape of the capacitor in the present embodiment. In FIG. 3, reference numeral 9 denotes uneven portions, reference character 9a denotes recessed portions, and reference character 9b denotes convex portions.

The norbornene resin has high rigidity and low viscosity and thus can be easily molded. Thus as shown in FIG. 3, the fine uneven portions 9 can be easily formed on the surface of the outer package 4 to increase the surface area. By increasing the surface area thus, heat radiation can be increased and the reliability of the capacitor can be improved.

The uneven portions 9 are formed by successively providing the recessed portions 9a or the convex portions 9b at regular intervals on the surface of the outer package 4. In the present embodiment, the recessed portions are substantially rectangular. The shapes of the recessed portions are not limited and may be substantially circular or polygonal.

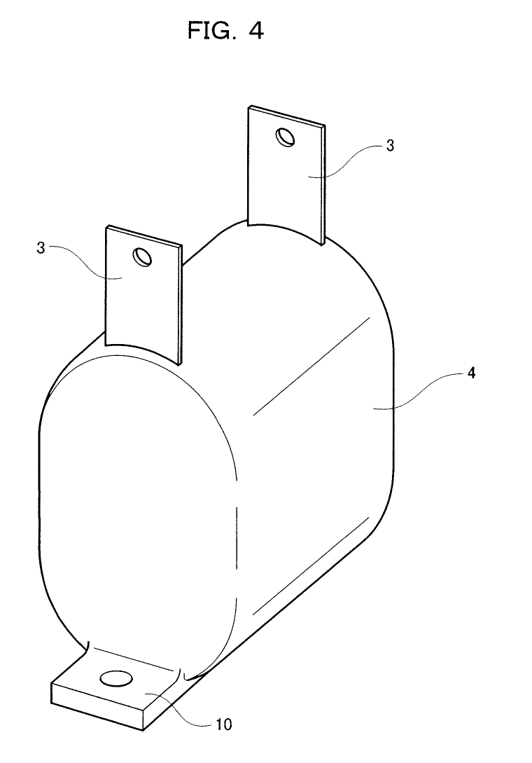

FIG. 4 shows another example of the capacitor in the present embodiment. In FIG. 4, reference numeral 10 denotes a mounting part. As has been discussed, the norbornene resin can be easily molded and has high mechanical strength. Thus as shown in FIG. 4, the mounting part 10 can be integrally formed on the outer package 4 to easily fix the capacitor.

As has been discussed, according to the present embodiment, the capacitor element is covered with the outer package made of the norbornene resin, so that moisture resistance can be obtained. Further, when the cross section of the capacitor element is formed into a track shape to increase the volumetric efficiency, it is possible to obtain moisture resistance and further reduce the size of the capacitor.

In the present embodiment, the metallized film capacitor was described as an example. The electronic component of the present invention is not limited to the metallized film capacitor. The present invention is also applicable to other electronic components and is useful for electronic components requiring moisture resistance.

The following will describe the results of a characteristic test on a molded article of the norbornene resin. In this test, norbornene resin materials were liquid A containing dicyclopentadiene and an aluminum alkyl halide activator and liquid B containing dicyclopentadiene and a metathesis polymerization catalyst of molybdenum (both are PENTAM3000 of RIMTEC Corporation). As a filler, a hybrid filler was used which had been prepared by stirring Wollastonite (KINSEI MATEC CO., LTD.) and calcium carbonate (Sankyo Flour Milling Co., Ltd.) with a Henschel mixer at a rotation speed of 720 rpm (a circumferential speed of 40 m/second) for ten minutes.

First, the liquids A and B were injected into the mold by using a RIM machine and a 3-mm plate (dicyclopentadiene resin not containing filler) was produced. At this point, the temperature of the mold was 80° C. Next, liquid C was prepared by dispersing a hybrid filler of 60 wt % into dicyclopentadiene and the liquids A, B and C were injected into the mold with a volume ratio of 1:1:1 by using the RIM machine, so that a 3-mm plate (dicyclopentadiene resin containing filler) was produced. The concentration of the filler in the plate was 28 wt %.

Table 1 shows the measurement results of mechanical strengths, coefficients of linear expansion, and coefficients of water absorption of these plates. Table 1 also shows as a comparative example the catalog values of an epoxy resin of two-liquid thermosetting type (Nippon Pelnox Corporation, WE-20/HV-19) for a film capacitor.

TABLE 1
Comparison of Physical Properties

| | Dicyclopentadiene | | |
|---|---|---|---|
| | resin (not | Dicyclopentadiene | Com. Ex.: |
| | containing | resin (containing | epoxy |
| Properties | filler) | filler) | resin |
| Heat distortion | 120° C. | 130° C. | 72° C. |
| temperature | | | |
| Bending strength | 80 MPa | 76 MPa | 137 MPa |
| Bending modulus | 2000 MPa | 4290 MPa | 2750 MPa |
| (X-direction)* | | | |
| Coefficient of | 7 × 10⁻⁵/° C. | 2 × 10⁻⁵/° C. | 7.8 × |
| linear expansion | | | 10⁻⁵/° C. |
| (X-direction)* | | | |
| Coefficient of | 0.12% | 0.38% | 0.62% |
| water | (24 hours) | (24 hours) | (2 hours) |
| absorption** | | | |
| (100° C. water) | | | |
| Coefficient of | 0.09% | | |
| water | (24 hours) | | |
| absorption** | | | |
| (23° C. water) | | | |

*X direction is the direction of a liquid flow during molding
**The coefficient of water absorption (24 hours) is a ratio of change after 24 hours and the coefficient of water absorption (2 hours) is a ratio of change after two hours.

As shown in Table 1, the dicyclopentadiene resin not containing a filler had a much smaller coefficient of water absorption in change ratio and a higher heat distortion temperature than the epoxy resin, and had about the same coefficient of linear expansion as the epoxy resin. Further, the dicyclopentadiene resin containing a filler had a smaller coefficient of water absorption in change ratio and a higher heat distortion temperature than the epoxy resin, and had a coefficient of linear expansion about one third as large as the coefficient of linear expansion of the epoxy resin.

The following will describe the results of a characteristic test conducted using the liquids A, B and C on a metallized film capacitor (specific example) produced by molding an outer package according to RIM illustrated in FIG. 2. In this test, a filler of 30 wt % was added.

In this test, an examination was conducted in which a direct current of 650 V was applied for 1000 hours at 85° C. and a relative humidity of 85% in the specific example. Before and after the examination, a capacitance and tan δ indicating a loss ratio were measured at 1 kHz and an insulation resistance was measured. The measurement results are shown in Table 2 with the weights and volume of products. In a comparative example, a capacitor element similar to the capacitor element (metallized film) used in the specific example was placed in a resin case made of polyphenylene sulfide, and an epoxy resin was filled into the case and was cured, so that a metallized film capacitor was produced, and then the same test as in the specific example was conducted. The measurement results of a capacitance, tan δ and insulation resistance in the comparative example are shown in Table 2 with the weights and volume of products.

TABLE 2

| | | | Capacitance | tanδ | Resistance |
|---|---|---|---|---|---|
| | | | change | change | change |
| | Weight | Volume | ratio | ratio | ratio |
| Specific | 175 g | 125 cc | 0% | 0% | 0% |
| example | | | | | |
| Com. Ex. | 241 g | 151 cc | −15% | +1000% | −500% |

As shown in Table 2, the specific example had a smaller volume and a lighter weight and achieved a smaller capacitance, tan δ, and insulation resistance in change ratio than the comparative example. This is because in the comparative example, moisture penetrated the case and reached the capacitor element. That is, the insulation resistance decreased due to the moisture. Further, the evaporated electrode of the capacitor element (metallized film) was eroded by the moisture, so that the film resistance of the evaporated electrode and tan δ were increased. Moreover, the evaporated electrode of the capacitor element was eroded by the moisture, so that the evaporated electrode could not act as an electrode and the capacitance was reduced.

Thus in the comparative example, the capacitance decreased and the insulation resistance decreased, whereas in the specific example, the outer package made of dicyclopentadiene resin (norbornene resin) achieved moisture resistance and thus reduced a decrease in capacitance and a decrease in resistance.

### INDUSTRIAL APPLICABILITY

An electronic component and a method for producing the same according to the present invention have a capacitor element covered with an outer package made of a norbornene resin having high rigidity, thereby reducing the size of a capacitor while achieving moisture resistance. Thus it is possible to increase the reliability of the capacitor fed with a large current at high humidities, so that the present invention is useful for an automobile system and the like.

1. An electronic component comprising:
a capacitor element;
an outer package made of a norbornene resin covering the capacitor element; and
external connection terminal portions electrically connected to the capacitor element and protruded from the outer package.

2. The electronic component according to claim 1, wherein the outer package is made of the norbornene resin in which a filler of 5 wt % to 50 wt % is added.

3. The electronic component according to claim 1, further comprising a pair of positive and negative electrodes provided on the capacitor element; and
conductive members which are connected to the respective electrodes and a part of which compose the external connection terminal portions.

4. The electronic component according to claim 1, wherein the capacitor element is made up of metallized films which are wound or stacked.

5. The electronic component according to claim 1, wherein the capacitor element has a track-shaped cross section.

6. The electronic component according to claim 1, further comprising uneven portions formed on a surface of the outer package.

7. A method for producing an electronic component according to claim 1, after the capacitor element is mounted in a mold for resin molding, the method comprising:
injecting a norbornene monomer from a resin inlet formed on the mold; and
molding the outer package for covering the capacitor element, according to reaction injection molding in which the injected norbornene monomer is caused to react and cured.
